(19) United States
(12) Patent Application Publication
(10) Pub. No.: US 2020/0086528 A1
(43) Pub. Date: Mar. 19, 2020

(54) METHODS AND SYSTEM FOR PRODUCING UNIDIRECTIONAL FIBER TAPES

(71) Applicants: SABIC Global Technologies B.V., Bergen op Zoom (NL); Fibre Reinforced Thermoplastics B.V., Lelystad (NL)

(72) Inventors: Guillaume RATOUIT, Elsloo (NL); Joris WISMANS, Elsloo (NL); Rinus PRINS, Elsloo (NL)

(21) Appl. No.: 16/494,017

(22) PCT Filed: Mar. 13, 2018
(86) PCT No.: PCT/IB2018/051673

§ 371 Date: Sep. 13, 2019

Related U.S. Application Data
(60) Provisional application No. 62/470,866, filed on Mar. 13, 2017.

(51) Int. Cl. B29B 15/12

(52) U.S. Cl. CPC B29B 15/122; B29K 2069/00

(57) ABSTRACT

Unidirectional fiber tapes include a matrix material including a thermoplastic material and a plurality of fibers dispersed within the matrix material, wherein the tape has a thickness that is between 0.07 mm and 0.30 mm. The tapes have a mean relative fiber area coverage of from 65 to 90 and a coefficient of variance of from 3 to 20. In the tapes, the fibers comprise carbon fibers, and the tape has a fiber volume fraction that is greater than 50%.

### CROSS-REFERENCE TO RELATED APPLICATIONS

This application claims the benefit of priority of U.S. Provisional Patent Application No. 62/470,866 filed Mar. 13, 2017, which is hereby incorporated by reference in its entirety.

### BACKGROUND

### 1. Field of Invention

The present invention relates generally to unidirectional fiber tapes (“UD tapes”), and more specifically, to thin (e.g., having thicknesses that are approximately 0.30 millimeters (mm) or less) UD tapes with high fiber volume fractions (e.g., greater than 50%) and/or uniform densities (defined as mean relative fiber area coverages (%) (“RFAC”) of from 65 to 90 and coefficients of variance (%) (“COV”) of from 3 to 20), and methods and systems for producing the same.

### 2. Description of Related Art

UD tapes can be used to make structures having advantageous structural characteristics, such as high stiffnesses and high strengths, as well as low weights, when compared to structures formed from conventional materials. As a result, UD tapes are used in a variety of applications across a wide range of industries, including the automotive, aerospace, and consumer electronics industries. Depending on its application, a UD tape may need to meet a number of criteria, including those relating to strength, stiffness, size, weight, and/or the like, and the UD tape may need to meet those criteria consistently.

Challenges associated with conventional UD tape production techniques may render them unable to produce a UD tape that meets the desired criteria. For example, conventional impregnation techniques may be incapable of sufficiently impregnating a bed of fibers with a matrix material, which can result in a UD tape having an undesirably low fiber volume fraction, uneven density, large thickness, high weight, and/or the like. This issue may be exacerbated when the bed of fibers has a low permeability (e.g., as in a bed of carbon fibers) and/or when the matrix material has a low melt strength and/or a high viscosity (e.g., as in a high-temperature polymer).

Additionally, conventional solvent-based impregnation techniques may be undesirably expensive and/or complicated due to, for example, the need for solvent as well as the need to evaporate the solvent from the impregnated bed of fibers and/or dispose of or recycle the solvent. Likewise, conventional aqueous-based impregnation techniques may be undesirably expensive and/or complicated due to, for example, the need to prepare an aqueous slurry of the matrix material, which typically requires producing a fine powder of the matrix material.

### SUMMARY

Solutions to the deficiencies noted above have been discovered. In particular, processing techniques have been discovered that allow for consistent and scalable production of a UD tape that has certain properties, such as a small as well as a uniform density and/or a high fiber volume fraction. Such processing techniques can include the use of first and second spreaded fiber layers, where: (1) the second spreaded fiber layer has at least 10% more fibers than the first spreaded fiber layer, matrix material is introduced into the second spreaded fiber layer, and the first and second spreaded fiber layers are pressed together; and/or (2) matrix material is introduced into the second spreaded fiber layer by moving the second spreaded fiber layer in a first direction underneath and relative to an outlet of a die of an extruder while matrix material is extruded through the outlet in an extrusion direction that is perpendicular to or has a component that is counter to the first direction, and the first and second spreaded fiber layers are pressed together. Without wishing to be bound by theory, it is believed that these enumerated processing techniques, which can be used alone or in combination, facilitate impregnation of the spreaded fiber layers, resulting in a UD tape having advantageous properties when compared with currently available UD tapes.

Some embodiments of the present UD tapes comprise a matrix material including a thermoplastic material and a plurality of fibers dispersed within the matrix material, where the tape has a thickness that is between 0.07 and 0.30 mm. Some such UD tapes have a mean RFAC of from 65 to 90 and a COV of from 3 to 20. Some such UD tapes have a fiber volume fraction that is greater than 50%. Thus, some of the present UD tapes can be thin, while having a uniform density and/or a high fiber volume fraction. Some of the present UD tapes can possess these desirable characteristics despite comprising fibers, that when spread into a spreaded fiber layer, have a relatively low permeability (e.g., carbon fibers).

Some embodiments of the present methods can be used to produce a thin tape having a uniform density and/or a high fiber volume fraction using a melt-based impregnation technique, which may avoid the cost and/or complexity of a solvent- or aqueous-based impregnation technique.

For example, some of the present methods include: (1) spreading a first set of one or more fiber bundles into a first spreaded fiber layer and spreading a second set of one or more fiber bundles into a second spreaded fiber layer having at least 10% more fibers than the first spreaded fiber layer; (2) using an extruder to introduce matrix material into the second spreaded fiber layer; and (3) pressing the first and second spreaded fiber layers together. Including less fibers in the first spreaded fiber layer can increase its permeability, thereby facilitating impregnation of the first spreaded fiber layer when the first and second spreaded fiber layers are pressed together.

For further example, some of the present methods include: (1) spreading first and second sets of one or more fiber bundles into first and second spreaded fiber layers, respectively; (2) introducing matrix material into the second spreaded fiber layer at least by: (a) moving the second spreaded fiber layer in a first direction underneath and relative to an outlet of a die of an extruder; and (b) extruding matrix material through the outlet in an extrusion direction that is perpendicular to or has a component that is counter to the first direction; and (3) pressing the first and second spreaded fiber layers together. In some methods, the second spreaded fiber layer contacts or comes in close proximity to (e.g., within 5 mm of) the die. Some methods comprise passing the second spreaded fiber layer underneath a scraper—which may be part of the die—having a downstream portion and an upstream portion, where a distance between the second spreaded fiber layer and the upstream portion is larger than a corresponding (i.e., measured in the same direction) distance between the second spreaded fiber layer and the downstream portion such that matrix material accumulates between the scraper and the second spreaded fiber layer. In at least some of these ways, matrix material from the die can be pushed into the second spreaded fiber layer, thereby facilitating impregnation of the second spreaded fiber layer.

Disclosed herein are embodiments 1-53. Embodiment 1 is a method for producing a unidirectional fiber tape, the method comprising: spreading a first set of one or more fiber bundles into a first spreaded fiber layer, spreading a second set of one or more fiber bundles into a second spreaded fiber layer having at least 10% more fibers than the first spreaded fiber layer, introducing matrix material into the second spreaded fiber layer at least by moving the second spreaded fiber layer underneath and relative to an outlet of a die of an extruder and extruding matrix material through the outlet, and producing the tape at least by pressing the first and second spreaded fiber layers together.

Embodiment 2 is embodiment 1, wherein the second set of one or more fiber bundles includes at least one more fiber bundle than the first set of one or more fiber bundles.

Embodiment 3 is embodiment 1 or 2, wherein introducing matrix material into the second spreaded fiber layer is performed such that the second spreaded fiber layer is moved in a first direction underneath and relative to the outlet of the die, and matrix material is extruded through the outlet in an extrusion direction that is perpendicular to or has a component that is counter to the first direction.

Embodiment 4 is a method for producing a unidirectional fiber tape, the method comprising: spreading a first set of one or more fiber bundles into a first spreaded fiber layer, spreading a second set of one or more fiber bundles into a second spreaded fiber layer, introducing matrix material into the second spreaded fiber layer at least by moving the second spreaded fiber layer in a first direction underneath and relative to an outlet of a die of an extruder and extruding matrix material through the outlet in an extrusion direction that is perpendicular to or has a component that is counter to the first direction, and producing the tape at least by pressing the first and second spreaded fiber layers together.

Embodiment 5 is embodiment 4, wherein the second spreaded fiber layer has at least 10% more fibers than the first spreaded fiber layer.

Embodiment 6 is embodiment 5, wherein the second set of one or more fiber bundles includes at least one more fiber bundle than the first set of one or more fiber bundles.

Embodiment 7 is any of embodiments 3-6, wherein an angle between the first direction and the extrusion direction is between approximately 85 degrees and 90 degrees.

Embodiment 8 is any of embodiments 3-7, wherein extruding matrix material through the outlet of the die comprises conveying matrix material through an interior passageway of the die and to the outlet, and the extrusion direction is parallel to a longitudinal axis of the interior passageway and/or perpendicular to a plane of the outlet.

Embodiment 9 is any of embodiments 1-8, wherein, during pressing the first and second spreaded fiber layers together the first spreaded fiber layer has a first width, and the second spreaded fiber layer has a second width that is substantially equal to the first width.

Embodiment 10 is any of embodiments 1-9, comprising passing the second spreaded fiber layer underneath a scraper having a downstream portion and an upstream portion, wherein a distance between the second spreaded fiber layer and the upstream portion is larger than a corresponding distance between the second spreaded fiber layer and the downstream portion such that matrix material accumulates between the scraper and the second spreaded fiber layer.

Embodiment 11 is embodiment 10, wherein the scraper is coupled to the die.

Embodiment 12 is any of embodiments 1-11, wherein a pressure within the extruder is between approximately 5 bar gauge and approximately 25 bar gauge.

Embodiment 13 is any of embodiments 1-12, wherein the first and second sets of one or more fiber bundles comprise unsized fibers.

Embodiment 14 is any of embodiments 1-13, wherein the first and second sets of one or more fiber bundles comprise carbon fibers, glass fibers, aramid fibers, polyethylene fibers, polyamide fibers, basalt fibers, steel fibers, or a combination thereof.

Embodiment 15 is embodiment 14, wherein the first and second sets of one or more fiber bundles comprise carbon fibers or glass fibers.

Embodiment 16 is any of embodiments 1-15, wherein the matrix material comprises a thermoplastic material comprising polyethylene terephthalate (PET), a polycarbonate (PC), polybutylene terephthalate (PBT), poly(1,4-cyclohexylidene cyclohexane-1,4-dicarboxylate) (PCCD), glycol modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polysulfone sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof.

Embodiment 17 is embodiment 16, wherein the thermoplastic material comprises polycarbonate, a polyamide, a copolymer thereof, or a blend thereof.

Embodiment 18 is any of embodiments 1-15, wherein the matrix material comprises a thermoset material comprising an unsaturated polyester resin, a polyurethane, bakelite, duroplast, urea-formaldehyde, diallyl-phthalate, epoxy resin, an epoxy vinylester, a polyimide, a cyanate ester of polycyanurate, dicyclopentadiene, a phenolic, a benzoxazine, a copolymer thereof, or a blend thereof.

Embodiment 19 is any of embodiments 1-18, wherein the tape has a fiber volume fraction that is greater than or equal to 35%.

Embodiment 20 is embodiment 19, wherein the fiber volume fraction is greater than 50%.

Embodiment 21 is embodiment 20, wherein the fiber volume fraction is less than or equal to 70%, optionally, the fiber volume fraction is between 65% and 70%.

Embodiment 22 is any of embodiments 1-21, wherein the tape has a thickness that is between 0.07 mm and 0.30 mm.

Embodiment 23 is embodiment 22, wherein the thickness is between 0.10 mm and 0.25 mm, optionally, the thickness is approximately 0.15 mm.

Embodiment 24 is any of embodiments 1-23, wherein the tape has a mean RFAC of from 65 to 90 and a COV of from 3 to 20.

Embodiment 25 is embodiment 24, wherein the mean RFAC is from 70 to 90 and the COV is from 3 to 15.

Embodiment 26 is embodiment 25, wherein the mean RFAC is from 75 to 90 and the COV is from 3 to 10.

Embodiment 27 is a method for producing a unidirectional fiber tape, the method comprising: spreading a first set of one or more fiber bundles into a first spreaded fiber layer, spreading a second set of one or more fiber bundles into a second spreaded fiber layer, introducing matrix material into the second spreaded fiber layer using an extruder, the matrix material comprising a thermoplastic material, and producing the tape at least by pressing the first and second spreaded fiber layers together, wherein the tape has a mean RFAC of from 65 to 90 and a COV of from 3 to 20 and a thickness that is between 0.07 mm and 0.30 mm.

Embodiment 28 is embodiment 27, wherein the mean RFAC is from 70 to 90 and the COV is from 3 to 15.

Embodiment 29 is embodiment 28, wherein the mean RFAC is from 75 to 90 and the COV is from 3 to 10.

Embodiment 30 is any of embodiments 27-29, wherein the first and second sets of one or more fiber bundles comprise carbon fibers, glass fibers, aramid fibers, basalt fibers, or a combination thereof.

Embodiment 31 is embodiment 30, wherein the first and second sets of one or more fiber bundles comprise carbon fibers or glass fibers.

Embodiment 32 is a method for producing a unidirectional fiber tape, the method comprising: spreading a first set of one or more fiber bundles, each comprising carbon fibers, into a first spreaded fiber layer, spreading a second set of one or more fiber bundles, each comprising carbon fibers, into a second spreaded fiber layer, introducing matrix material into the second spreaded fiber layer using an extruder, the matrix material comprising a thermoplastic material, and producing the tape at least by pressing the first and second spreaded fiber layers together, wherein the tape has a fiber volume fraction that is greater than 50% and a thickness that is between 0.07 mm and 0.30 mm.

Embodiment 33 is embodiment 32, wherein the fiber volume fraction is less than or equal to 70%, optionally, the fiber volume fraction is between 65% and 70%.

Embodiment 34 is embodiment 27, wherein the thermoplastic material comprises polycarbonate, the first and second sets of one or more fiber bundles each comprise carbon fibers, and: (1) the mean RFAC is approximately 71.6 and the COV is approximately 9.4; or (2) the mean RFAC is approximately 74.4 and the COV is approximately 6.8.

Embodiment 35 is any of embodiments 27-33, wherein the thermoplastic material comprises polyethylene terephthalate (PET), a polycarbonate (PC), polybutylene terephthalate (PBT), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), a polyamide (PA), polysulfone sulfonate (PSS), polyaryl ether ketone (PAEK), acrylonitrile butyldiene styrene (ABS), polyphenylene sulfide (PPS), polyether sulfone (PES), a copolymer thereof, or a blend thereof.

Embodiment 36 is embodiment 35, wherein the thermoplastic material comprises polycarbonate, a polyamide, a copolymer thereof, or a blend thereof.

Embodiment 37 is any of embodiments 27-36, wherein the thickness of the tape is between 0.10 mm and 0.25 mm, optionally, the thickness of the tape is approximately 0.15 mm.

Embodiment 38 is a system for producing a unidirectional fiber tape, the system comprising: an extruder having a die defining an outlet, and a first guiding element disposed upstream of the outlet and a second guiding element disposed downstream of the outlet, the guiding elements configured to contact a spreaded fiber layer to guide the spreaded fiber layer in a first direction underneath the outlet, wherein the extruder is configured to extrude matrix material through the outlet of the die in an extrusion direction that is perpendicular to or has a component that is counter to the first direction.

Embodiment 39 is embodiment 38, wherein an angle between the first direction and the extrusion direction is between approximately 85 degrees and 90 degrees.

Embodiment 40 is embodiment 38 or 39, comprising a scraper positioned downstream of the outlet, the scraper having a downstream portion and an upstream portion, wherein, optionally, the second guiding element comprises the scraper, and wherein, when the spreaded fiber layer is guided by the guiding elements, a distance between the spreaded fiber layer and the upstream portion is larger than a corresponding distance between the spreaded fiber layer and the downstream portion.

Embodiment 41 is embodiment 40, wherein the scraper is coupled to the die.

Embodiment 42 is any of embodiments 38-41, wherein at least one of the guiding elements comprises a bar or plate.

Embodiment 43 is a unidirectional fiber tape comprising: a matrix material including a thermoplastic material, and a plurality of fibers dispersed within the matrix material, wherein the tape has a mean RFAC of from 65 to 90 and a COV of from 3 to 20 and a thickness that is between 0.07 mm and 0.30 mm.

Embodiment 44 is embodiment 43, wherein the mean RFAC is from 70 to 90 and the COV is from 3 to 15.

Embodiment 45 is embodiment 44, wherein the mean RFAC is from 75 to 90 and the COV is from 3 to 10.

Embodiment 46 is any of embodiments 43-45, wherein the fibers comprise carbon fibers, glass fibers, aramid fibers, basalt fibers, or a combination thereof.

Embodiment 47 is embodiment 46, wherein the fibers comprise carbon fibers or glass fibers.

Embodiment 48 is a unidirectional fiber tape comprising: a matrix material including a thermoplastic material, and a plurality of carbon fibers dispersed within the matrix material, wherein the tape has a fiber volume fraction that is greater than 50%, and a thickness that is between 0.07 mm and 0.30 mm.

Embodiment 49 is embodiment 48, wherein the fiber volume fraction is between 50% and 70%, optionally, the fiber volume fraction is between 65% and 70%.

Embodiment 50 is embodiment 43, wherein the thermoplastic material comprises polycarbonate, the fibers comprise carbon fibers, and: (1) the mean RFAC is approximately 71.6 and the COV is approximately 9.4; or (2) the mean RFAC is approximately 74.4 and the COV is approximately 6.8.

Embodiment 51 is any of embodiments 43-49, wherein the thermoplastic material comprises polyethylene terephthalate (PET), a polycarbonate (PC), polybutylene terephthalate (PBT), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), a polyamide (PA), polysulfone sulfonate (PSS), polyaryl ether ketone (PAEK), acrylonitrile butyldiene styrene (ABS), polyphenylene sulfide (PPS), polyether sulfone (PES), a copolymer thereof, or a blend thereof.

Embodiment 52 is embodiment 51, wherein the thermoplastic material comprises polycarbonate, a polyamide, a copolymer thereof, or a blend thereof.

Embodiment 53 is any of embodiments 43-53, wherein the thickness of the tape is between 0.10 mm and 0.25 mm, optionally, the thickness of the tape is approximately 0.15 mm.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. Each of the figures, unless identified as a schematic view, is drawn to scale, meaning the sizes of the elements depicted in the figure are accurate relative to each other for at least the embodiment depicted in the figure.

FIG. 1 is a cross-sectional image of a prior art UD tape.

FIG. 2 is a schematic view illustrating the procedure for determining the mean RFAC and COV of a UD tape.

FIG. 3 is a schematic perspective view of one embodiment of the present UD tapes.

FIG. 4 is a flow chart of some embodiments of the present methods for producing a UD tape, including introducing matrix material into one of two spreaded fiber layers and pressing the spreaded fiber layers together.

FIG. 5 is a schematic side view of an embodiment of the present spreading systems that is for spreading first and second sets of fiber bundle(s) into respective first and second spreaded fiber layers.

FIG. 6 is a perspective view of the spreading system of FIG. 5.

FIG. 7 is a schematic perspective view of a spreading element of the spreading system of FIG. 5.

FIG. 8 is a schematic side view of an embodiment of the present impregnation systems, including an extruder having a die for introducing matrix material into a spreaded fiber layer.

FIGS. 9 and 10 are schematic cross-sectional side views of the die of the impregnation system of FIG. 8.

FIG. 11 is a perspective view of the impregnation system of FIG. 8.

FIG. 12 is a perspective view of an embodiment of the present impregnation systems.

FIG. 13 is a schematic side view of various components for pressing first and second spreaded fiber layers together.

FIG. 14 is a perspective view of some of the components of FIG. 13.

FIGS. 15 and 16 are each a cross-sectional image of an embodiment of the present UD tapes, annotated with the boxes and fiber counts used to determine mean RFAC and COV of that tape.

### DETAILED DESCRIPTION

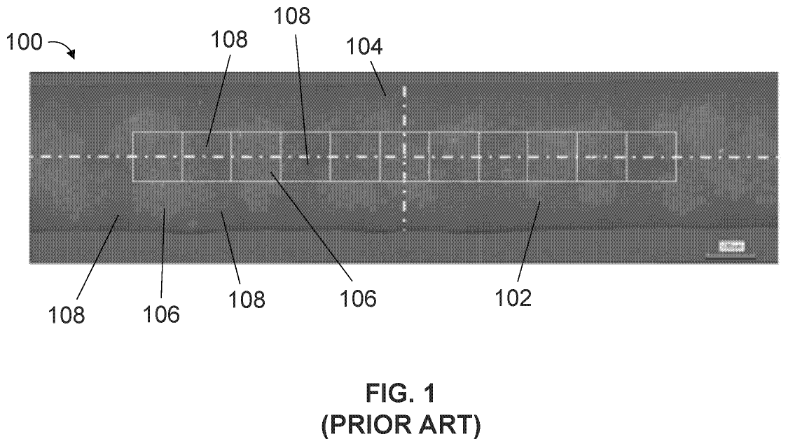

Existing UD tapes may have undesirably uneven densities, low fiber volume fractions, and/or high thicknesses. For example, FIG. 1 is a cross-sectional image of a prior art UD tape 100 including glass fibers 102 dispersed within a matrix material 104. For UD tape 100, the distribution of fibers 102 within matrix material 104—and thus the density of the tape—is uneven; for example, the fibers are grouped in clusters 106, and the matrix material is concentrated in generally fiberless pockets 108 disposed around the clusters. This uneven density can be quantified as a mean RFAC of 65.7 and a COV of 32.4 (see Example 2). Such an uneven density can render the performance of UD tape 100 inconsistent and unpredictable. Additionally, pockets 108 of matrix material 104, particularly those located above and below clusters 106 of fibers 102, can cause UD tape 100 to have an undesirably low fiber volume fraction (e.g., for use in applications where high strength and/or stiffness is important) as well as an undesirably high thickness (e.g., for use in space-restricted applications and/or for use in applications where low weight is important).

### A. UD Tapes of the Present Disclosure

As described in more detail below, the present UD tapes can be thin (e.g., having thicknesses that are approximately 0.30 mm or less) as well as possess high fiber volume fractions (e.g., greater than 50%) and/or uniform densities (e.g., defined as mean RFACs of from 65 to 90 and COVs of from 3 to 20).

1. Determining RFAC and COV

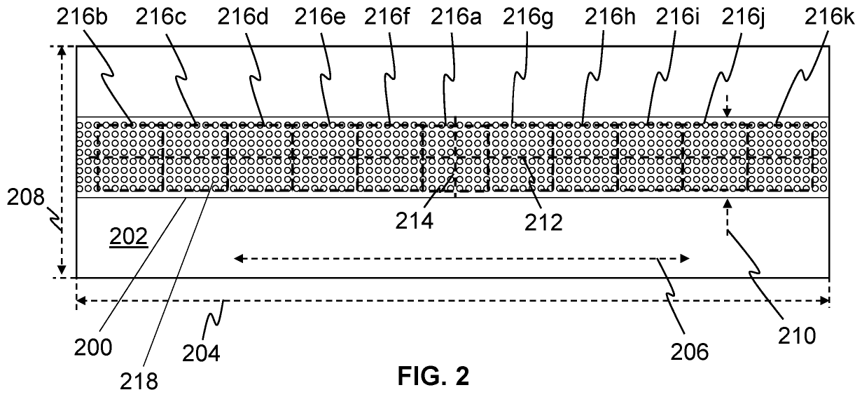

Referring additionally to FIG. 2, the mean RFAC and COV of a UD tape (e.g., 200) is determined using the following procedure:
1. A cross-sectional image 202 of the UD tape is taken perpendicularly to the length of the UD tape such that a width 204 of the image is aligned with a width (measured in direction 206) of the UD tape, and a height 208 of the image is aligned with a thickness 210 of the UD tape. Width 204 of image 202 is large enough for each of boxes 216a-216k (described below) to lie within the image, and height 208 of the image is large enough for the entire thickness 210 of the UD tape to be captured by the image. To produce the images discussed in the Examples section, a KEYENCE VK-X22 camera with a 50× lens was used; however, other cameras or imaging devices can be used.
2. Crosshairs, 212 and 214, are drawn on image 202 such that the crosshairs bisect the portion of the UD tape captured by the image along the width and the thickness of the UD tape.
3. A first square box 216a, having sides equal to approximately 80% of thickness 210 of the UD tape, is drawn centered where crosshairs 212 and 214 intersect.
4. Two sets of 5 adjacent square boxes, 216b-216f and 216g-216k, each of the boxes having the same dimensions as first square box 216a, are drawn on image 202 such that: (a) each of the sets is drawn on a respective side of thickness-wise crosshair 214; (b) each of the sets is adjacent to the first square box; and (c) for each of the sets, each of the boxes is centered on widthwise crosshair 212. A total of 11 boxes, 216a-216k, will be drawn on image 202.
5. For each of boxes 216a-216k, an area occupied by fibers 218 within the box is measured and is represented as a percentage of the total area of the box, referred to as an area coverage (AC) (%). An area occupied by fibers (e.g., 218) within a box (e.g., any of 216a-216k) can be approximated by counting each of the fibers for which a majority of the cross-section of the fiber lies within the box and multiplying that number by an average cross-sectional area of the fibers (which may be provided by the manufacturer of the fibers).
6. For each of boxes 216a-216k, an RFAC of the box is determined by dividing the AC of the box by the maximum theoretically possible AC of the box; if assuming fibers having circular cross-sections and square packing of those fibers within the box, it can be shown that the maximum theoretically possible AC is 78.5.
7. The mean RFAC of the UD tape is determined by averaging the RFACs of boxes 216a-216k.
8. The COV of the UD tape is determined by dividing the standard deviation (σ) of the ACs of boxes 216a-216k by the average of the ACs of the boxes and multiplying by 100.

2. Properties

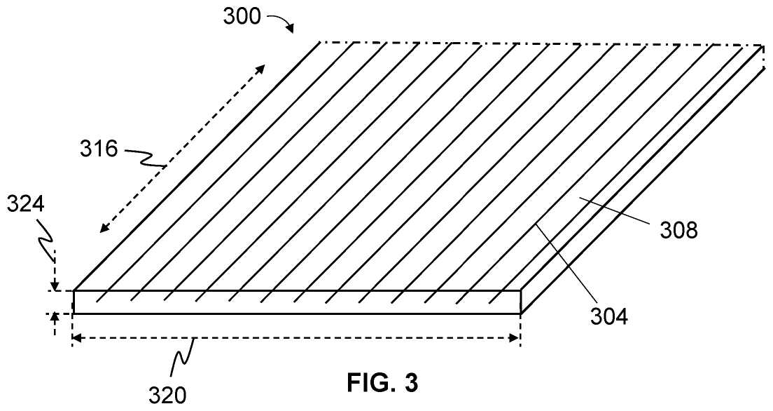

In this section, exemplary compositions, dimensions, and properties of the present UD tapes are disclosed. Provided by way of illustration, FIG. 3 is a schematic perspective view of one embodiment 300 of the present UD tapes, including fibers 304 dispersed within a matrix material 308.

In UD tape 300, fibers 304 can include carbon fibers, glass fibers, aramid fibers, basalt fibers, or a combination thereof (e.g., carbon fibers or glass fibers). Matrix material 308 of UD tape 300 can comprise a thermoplastic material, including polyethylene terephthalate (PET), a polycarbonate (PC), polybutylene terephthalate (PBT), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), a polyamide (PA), polysulfone sulfonate (PSS), polyaryl ether ketone (PAEK), acrylonitrile butyldiene styrene (ABS), polyphenylene sulfide (PPS), polyether sulfone (PES), a copolymer thereof, or a blend thereof (e.g., polycarbonate, a polyamide (e.g., polyamide 6, polyamide 66, and/or the like), a copolymer thereof, or a blend thereof).

In some UD tapes (e.g., 300), a matrix material (e.g., 308) of the UD tape can include a flame retardant, such as, for example, a phosphate structure (e.g., resorcinol bis(diphenyl phosphate)), a sulfonated salt, halogen, phosphorous, talc, silica, a hydrated oxide, a brominated polymer, a chlorinated polymer, a phosphorated polymer, a nanoclay, an organoclay, a polyphosphonate, a poly[phosphonate-co-carbonate], a polytetrafluoroethylene and styrene-acrylonitrile copolymer, a polytetrafluoroethylene and methyl methacrylate copolymer, a polysilixane copolymer, and/or the like.

In some UD tapes (e.g., 300), a matrix material (e.g., 308) of the UD tape can include one or more additives, such as, for example, a coupling agent to promote adhesion between the matrix material and fibers (e.g., 304) of the UD tape, an antioxidant, a heat stabilizer, a flow modifier, a stabilizer, a UV stabilizer, a UV absorber, an impact modifier, a cross-linking agent, a colorant, or a combination thereof. Non-limiting examples of a coupling agent include POLYBOND 3150 maleic anhydride grafted polypropylene, commercially available from DUPONT, FUSABOND P613 maleic anhydride grafted polypropylene, commercially available from DUPONT, maleic anhydride ethylene, or a combination thereof A non-limiting example of a flow modifier is CR20P peroxide masterbatch, commercially available from POLYVEL INC. A non-limiting example of a heat stabilizer is IRGANOX B 225, commercially available from BASF. Non-limiting examples of UV stabilizers include hindered amine light stabilizers, hydroxybenzophenones, hydroxyphenyl benzotriazoles, cyanoacrylates, oxanilides, hydroxyphenyl triazines, and combinations thereof. Non-limiting examples of UV absorbers include 4-substituted-2-hydroxybenzophenones and their derivatives, aryl salicylates, monoesters of diphenols, such as resorcinol monobenzoate, 2-(2-hydroxyaryl)-benzotriazoles and their derivatives, 2-(2-hydroxyaryl)-1,3,5-triazines and their derivatives, or combinations thereof. Non-limiting examples of impact modifiers include Non-limiting examples of impact modifiers include elastomers/soft blocks dissolved in one or more matrix-forming monomers (e.g., bulk HIPS, bulk ABS, reactor modified PP, LOMOD, LEXAN EXL, and/or the like), thermoplastic elastomers dispersed in a matrix material by compounding (e.g., di-, tri-, and multiblock copolymers, (functionalized) olefin (co)polymers, and/or the like), pre-defined core-shell (substrate-graft) particles distributed in a matrix material by compounding (e.g., MBS, ABS-HRG, AA, ASA-XTW, SWIM, and/or the like), or combinations thereof. Non-limiting examples of cross-linking agents include include divinylbenzene, benzoyl peroxide, alkylenediol di(meth)acrylates (e.g., glycol bisacrylate and/or the like), alkylenetriol tri(meth)acrylates, polyester di(meth)acrylates, bisacrylamides, triallyl cyanurate, triallyl isocyanurate, allyl (meth)acrylate, diallyl maleate, diallyl fumarate, diallyl adipate, triallyl esters of citric acid, triallyl esters of phosphoric acid, or combinations thereof. In some UD tapes (e.g., 300), such an additive can comprise neat polypropylene.

UD tape 300 can have any suitable length (e.g., measured in direction 316) and any suitable width 320. For example, the length of UD tape 300 can be greater than or substantially equal to any one of, or between any two of: 1, 2, 3, 4, 5, 6, 7, 8, 9, 10, 12, 14, 16, 18, 20, 25, 30, 35, 40, 45, 50, 55, 60, 70, 80, 90, or 100 meters (m). For further example, width 320 of UD tape 300 can be greater than or substantially equal to any one of, or between any two of: 1, 2, 3, 4, 5, 6, 7, 8, 9, 10, 12, 14, 16, 18, 20, 25, 30, 35, 40, 45, 50, 55, 60, 70, 80, 90, or 100 centimeters (cm). UD tape 300 is thin; for example, a thickness 324 of the UD tape, which can be an average thickness of the UD tape, is less than or substantially equal to any one of, or between any two of: 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, or 0.30 mm (e.g., between 0.07 mm and 0.30 mm, between 0.10 mm and 0.25 mm, or approximately 0.15 mm).

UD tape 300 can have a high fiber volume fraction and/or a uniform density. For example, a fiber volume fraction of UD tape 300 can be greater than or substantially equal to any one of, or between any two of: 50, 52, 54, 56, 58, 60, 62, 64, 66, 68, or 70% (e.g., greater than 50%, greater than 50% and less than or equal to 70%, or between 65 and 70%). A UD tape (e.g., 300) having a higher fiber volume fraction may possess a higher strength and/or stiffness than a UD tape (e.g., 100) having a lower fiber volume fraction. For further example, UD tape 300 can have a mean RFAC of from 65 to 90 and a COV of from 3 to 20, more preferably, a mean RFAC of from 70 to 90 and a COV of from 3 to 15, and even more preferably, a mean RFAC of from 75 to 90 and a COV of from 3 to 10. A UD tape (e.g., 300) having a more uniform density may perform more consistently and predictably than a UD tape (e.g., 100) having a less uniform density.

At least by being thin and having a high fiber volume fraction and/or a uniform density, UD tape 300 may be more structurally efficient than existing UD tapes; to illustrate, UD tape 300 may have a smaller size and/or weight than an existing UD tape of similar strength and/or stiffness, a higher strength and/or stiffness than an existing UD tape of similar size and/or weight, and/or the like. Such desirable characteristics of a UD tape (e.g., 300) can be obtained, at least in part, by effective spreading of fibers (e.g., 304) and effective impregnation of those fibers with a matrix material (e.g., 308) during manufacture of the UD tape. Non-limiting examples of methods and systems for achieving such effective spreading and impregnation are disclosed below.

### B. Methods and Systems for Producing UD Tapes

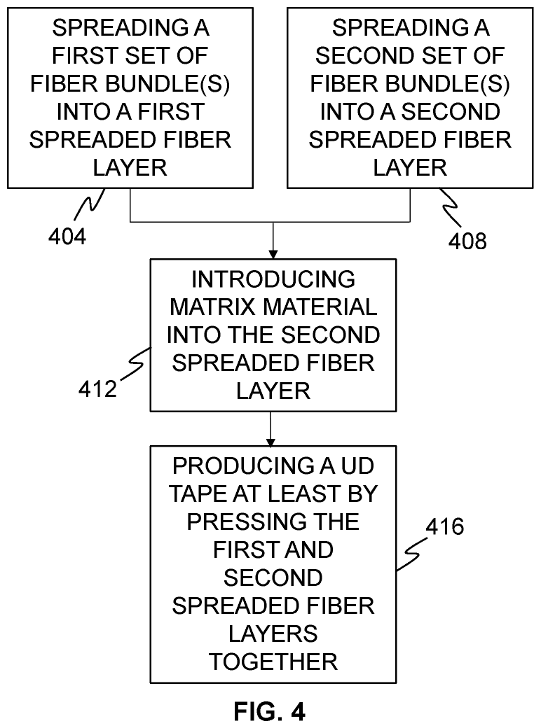

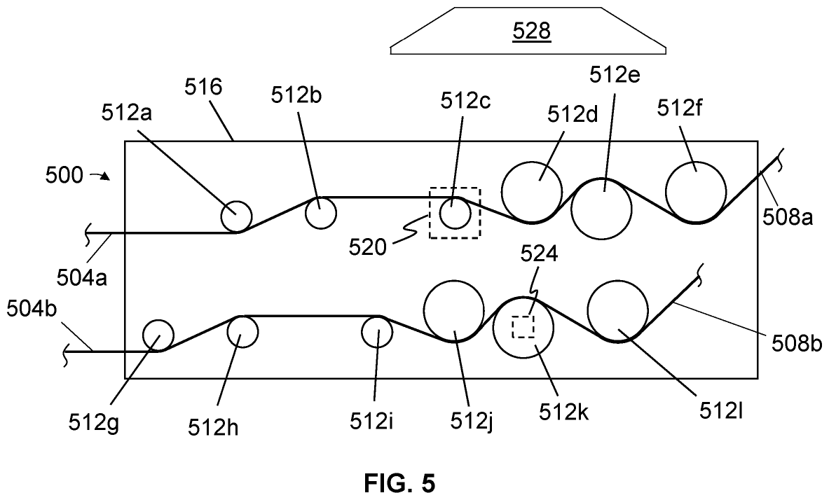

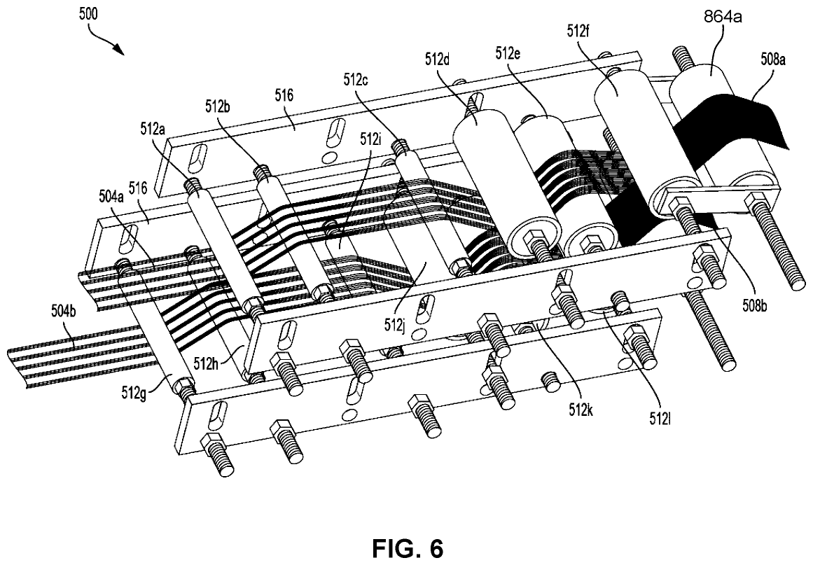

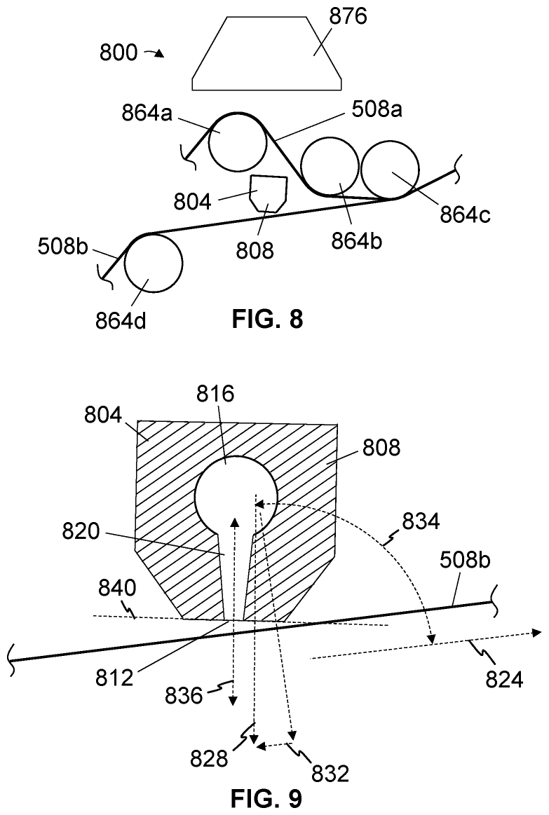

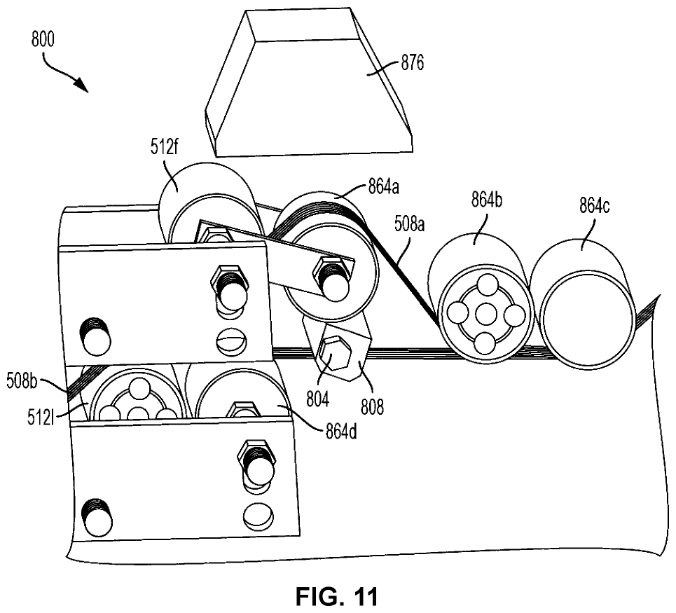

FIG. 4 depicts embodiments of the present methods for producing UD tapes. As described below, a UD tape can be produced by spreading first and second sets of one or more fiber bundles into respective first and second spreaded fiber layers (steps 404 and 408), introducing matrix material into the second spreaded fiber layer (step 412), and pressing the first and second spreaded fiber layers together (step 416). Embodiments of the present spreading systems (e.g., 500, FIGS. 5-7) and impregnation systems (e.g., 800, FIGS. 8-11) are referenced below to illustrate methods of FIG. 4; however, these systems are not limiting on those methods, which can be performed using any suitable systems.

Referring additionally to FIGS. 5-7, some methods comprise a step 404 of spreading a first set of one or more fiber bundles (e.g., 504a) into a first spreaded fiber layer (e.g., 508a) and a step 408 of spreading a second set of one or more fiber bundles (e.g., 504b) into a second spreaded fiber layer (e.g., 508b). The fiber bundles, which can be characterized as strands, rovings, and/or tows of fibers, can comprise any suitable fibers, such as, for example, carbon fibers, glass fibers, aramid fibers, polyethylene fibers, polyamide fibers, basalt fibers, steel fibers, or a combination thereof. In some methods, fiber bundles (e.g., 504a and 504b) can comprise unsized fibers. Such unsized fibers may be uncoated and/or may not comprise a sizing material, such as, for example, epoxy, polyester, nylon, polyurethane, urethane, a coupling agent (e.g., an alkoxysilane), a lubricating agent, an antistatic agent, a surfactant, and/or the like. Fiber bundles (e.g., 504a and 504b) having unsized fibers may be more easily spread into spreaded fiber layers (e.g., 508a and 508b) than fiber bundles having sized fibers (e.g., sizing material may increase the tendency of fibers to stick to one another).

Each of the fiber bundles can include any suitable number of fibers; for example, each fiber bundle can include between 250 and 610,000 fibers, the fiber bundle can be a 1K, 3K, 6K, 12K, 24K, 30K, 50K, or larger fiber bundle, and/or the like. The fiber bundles can be provided on reels from which the fiber bundles can be unwound and provided to a spreading system (e.g., 500) for spreading the fiber bundles into the first and second spreaded fiber layers.

Provided by way of illustration, spreading system 500 can include a first set of spreading elements, 512a-512f, for spreading a first set of fiber bundle(s) 504a into a first spreaded fiber layer 508a and a second set of one or more spreading elements, 512g-512l, for spreading a second set of fiber bundle(s) 504b into a second spreaded fiber layer 508b. To illustrate, the first set of one or more fiber bundle(s) can include any suitable number of fiber bundle(s) (e.g., 1, 2, 3, 4, 5, 6, 7, 8, 9, or more fiber bundle(s)), which can together be passed under and over spreading elements of the first set of spreading elements to spread the fiber bundle(s) into the first spreaded fiber layer. Similarly, the second set of one or more fiber bundle(s) can include any suitable number of fiber bundle(s) (e.g., 1, 2, 3, 4, 5, 6, 7, 8, 9, or more fiber bundle(s)), which can together be passed under and over spreading elements of the second set of spreading elements to spread the fiber bundle(s) into the second spreaded fiber layer.

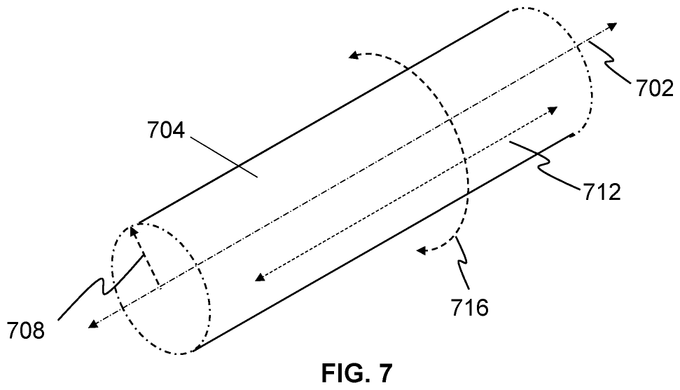

Each of spreading elements 512a-512l can be oriented substantially perpendicularly to fiber bundle(s) (first set of fiber bundle(s) 504a or second set of fiber bundle(s) 504b) spread by the spreading element. For example, the spreading elements can each comprise an elongated body (e.g., a bar or a plate) that contacts the fiber bundle(s) and has a longitudinal axis (e.g., 702, FIG. 7) that is substantially perpendicular to the fiber bundle(s). Spreading system 500 can include a frame 516 to which one or more of the spreading elements are coupled.

Spreading elements 512a-512l can each define a curved surface 704 that contacts the fiber bundle(s) to spread the fiber bundle(s). In spreading system 500, curved surface 704 of each of the spreading elements can be cylindrical. For example, each of the spreading elements can comprise a bar, where a portion of the bar that contacts the fiber bundle(s) is straight and has a circular cross-section that is substantially constant in diameter. During spreading of fiber bundle(s), such a cylindrical curved surface (e.g., 704), at least by having little to no slope in a direction that is perpendicular to the fiber bundle(s), can reduce forces exerted on, and thus mitigate breakage of, the fibers. Nevertheless, in other embodiments, a curved surface of each of one or more spreading elements can be spherical, ellipsoidal, hyperboloidal, conical, and/or the like. In some embodiments, one or more spreading elements can each comprise a curved plate—as opposed to a bar—that defines its curved surface.

Such a curved surface (e.g., 704) can have any suitable radius (e.g., 708) such as, for example, a radius that is greater than or substantially equal to any one of, or between any two of: 5.0, 5.5, 6.0, 6.5, 7.0, 7.5, 8.0, 8.5, 9.0, 9.5, 10.0, 11.0, 12.0, 13.0, 14.0, 15.0, 16.0, 17.0, 18.0, 19.0, 20.0, 21.0, 22.0, 23.0, 24.0, 25.0, 26.0, 27.0, 28.0, 29.0, or 30.0 mm. To illustrate, curved surface 704 of each of spreading elements 512a-512c and 512g-512i can have a radius 708 of approximately 6.30 mm, and curved surface 704 of each of spreading elements 512d-512f and 512j-512l can have a radius 708 of approximately 25.4 mm.

For each of spreading elements 512a-512l, curved surface 704 can be a low-friction surface; for example, the spreading element can comprise a low-friction material (e.g., a heat- or chemically-treated metal, such as steel), the spreading element can include a low-friction coating and/or plating, and/or the like. A non-limiting example of a low-friction plating is a hard chromium plating, such as that available from TOPOCROM. During spreading of fiber bundle(s), such a low-friction curved surface (e.g., 704) can reduce forces exerted on, and thus mitigate breakage of, the fibers.

At least one of spreading elements 512a-512l can be moved relative to fiber bundle(s) (first set of fiber bundle(s) 504a or second set of fiber bundle(s) 504b) during spreading of the fiber bundle(s) with the spreading element. For example, at least one of the spreading elements can be oscillated relative to the fiber bundle(s) and/or frame 516 in a direction 712 that is aligned with its longitudinal axis 702. Such oscillation can be achieved using a drive (e.g., 520), such as a motor, coupled to the spreading element. More particularly, in spreading system 500, spreading elements 512b, 512e, 512h, and 512k can be so oscillated. Such oscillation can be at any suitable amplitude, such as, for example, an amplitude that is greater than or substantially equal to any one of, or between any two of: 0.1, 0.2, 0.3, 0.4, 0.5, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, or 20.0 mm (e.g., from 0.1 mm to 20.0 mm, from 0.1 mm to 10 mm, from 0.5 mm to 8.0 mm, or from 1.0 mm to 5.0 mm), and at any suitable frequency, such as, for example, a frequency that is greater than or substantially equal to any one of, or between any two of: 0.1, 0.2, 0.3, 0.4, 0.5, 1.0, 1.5, 2.0, 2.5, 3.0, 3.5, 4.0, 4.5, or 5.0 hertz (Hz) (e.g., from 0.1 Hz to 5.0 Hz or from 0.5 Hz to 2.0 Hz). Such oscillation of a spreading element (e.g., any of 512a-512l) can facilitate spreading of fiber bundle(s) with the spreading element, by, for example, encouraging juxtaposition of the fibers.

For further example, at least one of spreading elements 512a-512l can be rotated relative to the fiber bundle(s) and/or frame 516 in a direction 716 about its longitudinal axis 702 during spreading of the fiber bundle(s) with the spreading element. Such rotation can be achieved via a drive (e.g., 520), such as a motor, coupled to the spreading element. Such rotation can be performed in an oscillating fashion at any suitable amplitude, such as, for example, an amplitude that is greater than or substantially equal to any one of, or between any two of: 0.5, 1.0, 1.5, 2.0, 2.5, 3.0, 3.5, 4.0, 4.5, 5.0, 6.0, 7.0, 8.0, 9.0, 10.0, 12.0, 14.0, 16.0, 18.0, or 20 degrees, and at any suitable frequency, such as, for example, any frequency described above. Ones of the spreading elements that are not so rotatable can be rotatably fixed relative to frame 316.

During spreading of first and second sets of fiber bundle(s), 504a and 504b, into first and second spreaded fiber layers, 508a and 508b, at least one of spreading elements 512a-512l can be heated. For example, a temperature of the spreading element can be greater than or substantially equal to any one of, or between any two of: 80, 90, 100, 110, 120, 130, 140, 150, 160, 170, 180, 190, or 200° C. (e.g., between approximately 100° C. and approximately 180° C.). Heating of a spreading element (e.g., any of 512a-512l) can be accomplished in any suitable fashion, such as, for example, via a heating element (e.g., 524) coupled to the spreading element. In spreading system 500, a heat source 528, such as an infrared heater, can be positioned to heat the fiber bundles as they are spread into the spreaded fiber layers. A temperature of heat source 528 can be any suitable temperature, such as, for example, any temperature described above for a heated spreading element. Heating of fiber bundle(s) can facilitate spreading of the fiber bundle(s) into a spreaded fiber layer and/or enhance impregnation of the spreaded fiber layer with matrix material.

Referring additionally to FIGS. 8-12, some methods comprise a step 412 of introducing matrix material into the second spreaded fiber layer (e.g., 508b). The matrix material can comprise a thermoplastic material or a thermoset material. Such a thermoplastic material can include, for example, polyethylene terephthalate (PET), a polycarbonate (PC), polybutylene terephthalate (PBT), poly(1,4-cyclohexylidene cyclohexane-1,4-dicarboxylate) (PCCD), glycol modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polysulfone sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof. Such a thermoset material can include, for example, an unsaturated polyester resin, a polyurethane, bakelite, duroplast, urea-formaldehyde, diallyl-phthalate, epoxy resin, an epoxy vinylester, a polyimide, a cyanate ester of polycyanurate, dicyclopentadiene, a phenolic, a benzoxazine, a copolymer thereof, or a blend thereof. The matrix material can comprise one or more of the flame retardants and/or additives described above.

To illustrate, matrix material can be introduced into the second spreaded fiber layer using an extruder 804 (e.g., an example of a melt-based impregnation technique). More particularly, the second spreaded fiber layer can be moved underneath and relative to an outlet 812 of a die 808 of the extruder while matrix material is extruded through the outlet. A pressure within extruder 804 (e.g., within die 808) can be any suitable pressure, such as, for example, a pressure that is greater than or substantially equal to any one of, or between any two of: 5, 6, 7, 8, 9, 10, 12, 14, 16, 18, 20, or 25 bar gauge (e.g., between approximately 5 bar gauge and approximately 25 bar gauge). A temperature within extruder 804 (e.g., within die 808) can be selected based on the composition of the matrix material.

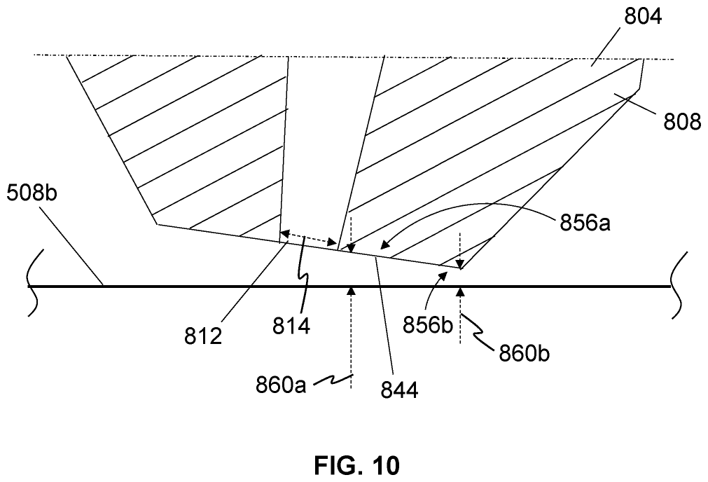

Matrix material from die 808 can be provided as a sheet or film; for example, outlet 812 can be an elongated slit. To illustrate, outlet 812 can have a width 814 (FIG. 10) that is less than or substantially equal to any one of, or between any two of: 0.2, 0.3, 0.4, 0.5, or 0.6 mm (e.g., between approximately 0.2 mm and approximately 0.6 mm). A length of outlet 812 (measured perpendicularly to width 814) can be substantially equal to a width of a portion of the second spreaded fiber layer that underlies the outlet. Die 808 can include an interior passageway 820 that extends to outlet 812 and through which matrix material can be provided to the outlet. Interior passageway 820 can be in fluid communication with a manifold or conduit 816 of die 808 such that matrix material can be provided from the manifold or conduit, through the interior passageway, and to outlet 812. During introduction of matrix material into the second spreaded fiber layer, the second spreaded fiber layer can be in contact with or in close proximity to die 808 (e.g., within 1, 2, 3, 4, or 5 mm of the die), and more particularly, the portion of the die that defines outlet 812. Such placement of the second spreaded fiber layer relative to die 808 can facilitate extruder 804 in pushing matrix material into the second spreaded fiber layer, thereby enhancing impregnation of the second spreaded fiber layer.

During introduction of matrix material into the second spreaded fiber layer, the second spreaded fiber layer can be moved in a first direction 824 underneath and relative to outlet 812, and matrix material can be extruded through the outlet in an extrusion direction 828 that is perpendicular to, or has a component 832 that is counter to, the first direction. Extrusion direction 828 can be parallel to a longitudinal axis 836 of interior passageway 820 and/or perpendicular to a plane 840 of outlet 812 (e.g., a plane in which at least a majority of the perimeter of the outlet lies). To illustrate, an angle 834 between first direction 824 and extrusion direction 828 can be less than or substantially equal to any one of, or between any two of: 70, 71, 72, 73, 74, 75, 76, 77, 78, 79, 80, 81, 82, 83, 84, 85, 86, 87, 88, 89, or 90 degrees (e.g., between approximately 85 degrees and 90 degrees). In at least this way, movement of the second spreaded fiber layer relative to die 808 can be used to encourage (or at least not discourage) urging of matrix material exiting the die into the second spreaded fiber layer.

Impregnation system 800 can include a scraper 844 disposed downstream of die outlet 812 and under which the second spreaded fiber layer can be passed (FIG. 10). Scraper 844 can include an upstream portion 856a and a downstream portion 856b, where a distance 860a between the second spreaded fiber layer and the upstream portion is larger than a corresponding (i.e., measured in the same direction) distance 860b between the second spreaded fiber layer and the downstream portion. The second spreaded fiber layer can be in contact with or in close proximity to scraper 844 (e.g., within 1, 2, 3, 4, or 5 mm of the scraper). In these ways, matrix material can accumulate between scraper 844 and the second spreaded fiber layer, and, via the inclined orientation of the scraper relative to the second spreaded fiber layer, be urged into the second spreaded fiber layer. As shown, scraper 844 is coupled to (e.g., forms part of) die 808; however, in other embodiments, a scraper and a die can be separate components. In impregnation system 800, a surface of scraper 844 that faces the second spreaded fiber layer is planar; however, in other embodiments, such a surface of a scraper can be curved (e.g., concave or convex).

Impregnation system 800 can include one or more guiding elements, 864a-864d, for guiding the first and second spreaded fiber layers relative to die 808; for example: guiding elements 864c and 864d can guide the second spreaded fiber layer underneath outlet 812 of the die; and guiding elements 864a-864c can guide the first spreaded fiber layer over the die. Such guiding elements can comprise bars, plates, rollers, and/or the like. Guiding elements 864a and 864d can be spreading elements and can comprise any of the features described above with respect to spreading elements 512a-512l. Additionally, guiding elements 864a and 864d can be considered components of a spreading system (e.g., 500). Guiding element 864c can be a pressing element and can comprise any of the features described below with respect to pressing elements 1304a-1304f Scraper 844, to the extent that it influences the path of the second spreaded fiber layer underneath die 808, can be characterized as a guiding element.

At least one of guiding elements 864a-864d can be heated (e.g., in a same or similar fashion as described above with respect to spreading elements 512a-512l). For example, a temperature of the guiding element can be greater than or substantially equal to any one of, or between any two of: 80, 90, 100, 110, 120, 130, 140, 150, 160, 170, 180, 190, or 200° C. (e.g., between approximately 100° C. and approximately 180° C.). In impregnation system 800, a heat source 876, such as an infrared heater, can be positioned to heat the spreaded fiber layers, which can enhance impregnation of the spreaded fiber layers. A temperature of heat source 876 can be any suitable temperature, such as, for example, a temperature described above for a heated guiding element.

Some methods comprise a step 416 of producing a UD tape (e.g., 1302) at least by pressing the first spreaded fiber layer (e.g., 508a) and the second spreaded fiber layer (e.g., 508b) together. For example, first spreaded fiber layer 508a and second spreaded fiber layer 508b can be directed under and in contact with a guiding element 864c (which can be a pressing element) such that the first spreaded fiber layer is disposed between the second spreaded fiber layer and the guiding element. In this way, the second spreaded fiber layer, having been introduced to a matrix material, can impregnate the first spreaded fiber layer with the matrix material when the spreaded fiber layers are pressed together.

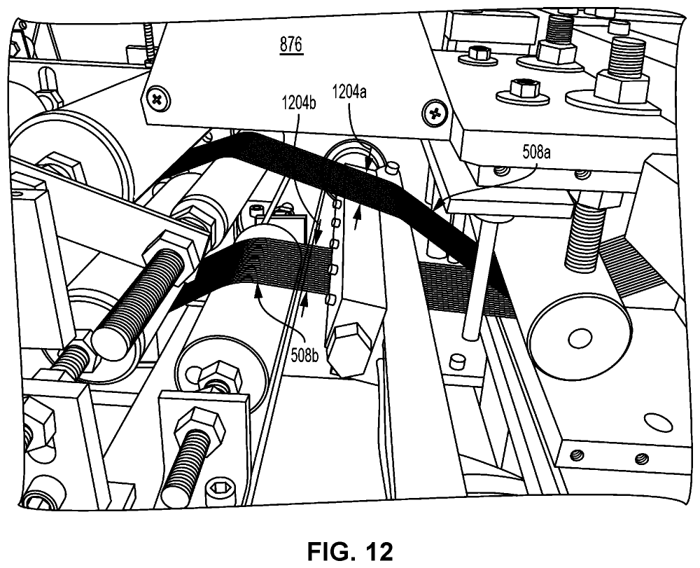

The second spreaded fiber layer can have at least 10% (e.g., at least 20%) more fibers than the first spreaded fiber layer. For example, second set of fiber bundle(s) 504b can comprise at least one more fiber bundle than first set of fiber bundle(s) 504a, and/or the fiber bundle(s) of the second set of fiber bundle(s) can each comprise more fibers than fiber bundle(s) of the first set of fiber bundle(s). Providing more fibers in the second spreaded fiber layer can reduce the loss of matrix material (e.g., from drips) during impregnation thereof, and providing less fibers in the first spreaded fiber layer can increase the permeability thereof, which may facilitate impregnation of the first spreaded fiber layer when the first spreaded fiber layer is pressed together with the second spreaded fiber layer. In such embodiments, despite the second spreaded fiber layer having more fibers than the first spreaded fiber layer, the first and second spreaded fiber layers can have substantially the same width (e.g., FIGS. 12, 1204a and 1204b, respectively).

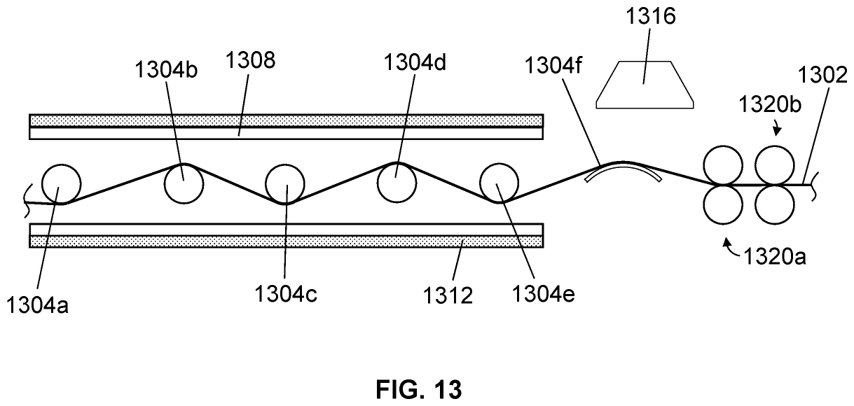

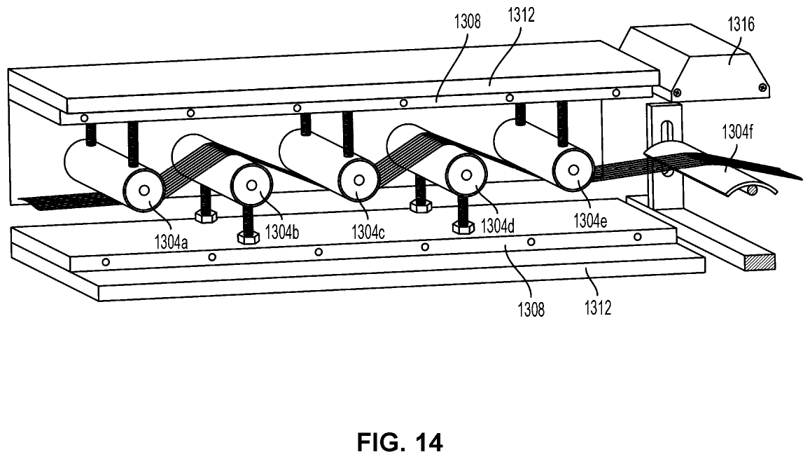

Referring additionally to FIGS. 13 and 14, pressing the first and second spreaded fiber layers together can be performed by passing the spreaded fiber layers over and/or under one or more pressing elements (e.g., 1304a-1304f). Each of the pressing element(s) can comprise, for example, a bar, a plate, a roller, or the like. To illustrate, pressing elements 1304a-1304e can each comprise a bar or a roller, and pressing element 1304f can comprise a plate. Such pressing element(s) can be considered component(s) of an impregnation system (e.g., 800); for example, pressing element 1304a can be guiding element 864c.

As the spreaded fiber layers are passed over and/or under the pressing element(s), the spreaded fibers layers can be heated to, for example, facilitate their consolidation. First, at least one of the pressing element(s) can be heated, which can be accomplished in a same or similar fashion as described above for spreading elements 512a-512l. To illustrate, a temperature of at least one of the pressing element(s) can be greater than or substantially equal to any one of, or between any two of: 80, 90, 100, 110, 120, 130, 140, 150, 160, 170, 180, 190, or 200° C. (e.g., between approximately 100° C. and approximately 180° C.). Second, a heat source 1316, such as an infrared heater, can be positioned above (or below or beside) at least some of the pressing element(s). Third, at least some of the pressing element(s) can be disposed between heated plates 1308, which can be insulated by insulative layers 1312.

The spreaded fiber layers can be passed through set(s) calendaring rolls, such as a first set of calendaring rolls 1320a and a second set of calendaring rolls 1320b (in that order). First set of calendaring rolls 1320a can be at a relatively high temperature, such as, for example, one that is greater than or substantially equal to any one of, or between any two of: 200, 210, 220, 230, 240, 250, 260, 270, 280, 290, or 300° C. (e.g., approximately 250° C.). Such a relatively high temperature can facilitate consolidation of the spreaded fiber layers. And, second set of calendaring rolls 1320b can be at a relatively low temperature, such as, for example, one that is less than or substantially equal to any one of, or between any two of: 50, 60, 70, 80, 90, 100, 110, or 120° C. (e.g., from 80 to 90° C.). Such a relatively low temperature can facilitate cooling of the spreaded fiber layers. In some embodiments, only one set of calendaring rolls is used, and that set of calendaring rolls can be at any suitable temperature, including any one described above for first set of calendaring rolls 1320a.

The present methods can be performed using any suitable line speed, such as, for example, a line speed that is greater than or substantially equal to any one of, or between any two of: 2.0, 2.5, 3.0, 3.5, 4.0, 4.5, 5.0, 5.5, 6.0, 6.5, 7.0, 7.5, 8.0, 8.5, 9.0, 9.5, 10.0, 11, 12, 13, 14, or 15 meters per minute (m/min) (e.g., between 2 m/min and 15 m/min or between 2 m/min and 6 m/min). A line speed can refer to a speed of first and second sets of fiber bundle(s) 504a and 504b passing through spreading system 500, a speed of first and second spreaded fiber layers 508a and 508b passing through impregnation system 800, and/or the like.

UD tapes (e.g., 1302) produced using the present methods can have the thicknesses, fiber volume fractions, and mean RFACs and COVs described above for UD tape 300.

### EXAMPLES

The present invention will be described in greater detail by way of specific examples. The following examples are offered for illustrative purposes only and are not intended to limit the invention in any manner. Those of skill in the art will readily recognize a variety of non-critical parameters that can be changed or modified to yield essentially the same results.

### Example 1

### Sample UD Tapes of the Present Disclosure

Two sample UD tapes (S1 and S2) were prepared using embodiments of the spreading and impregnation systems described above. For S1 and S2: (1) the fibers were high strength, normal modulus carbon fibers having thermoplastic 1% sizing; and (2) the matrix material included polycarbonate and had a melt volume-flow rate of 52.6 cm³/10 min (ASTM D 1238 according to Global Test Method at 300° C. and 1.2 kg). To produce each of S1 and S2, the temperature of the die was 290° C. The line speed used to produce 51 was 4 m/min, and the line speed used to produce S2 was 4.5 m/min.

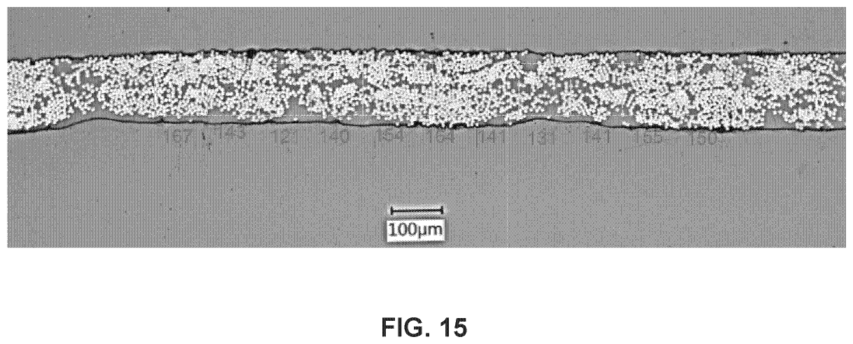

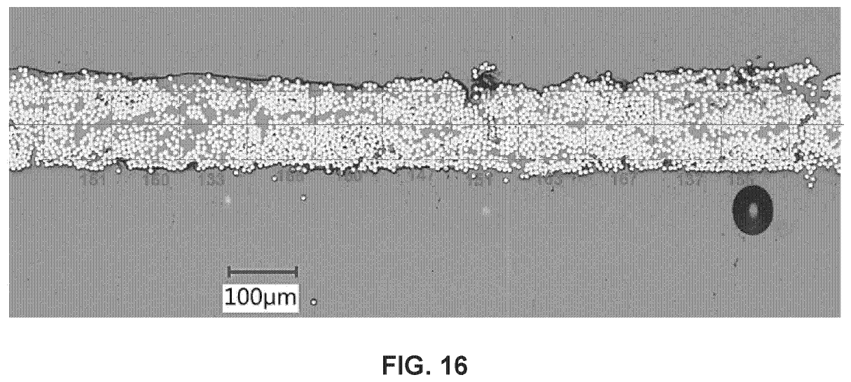

FIG. 15 is a cross-sectional image of S1 and FIG. 16 is a cross-sectional image of S2. Properties of S1 and S2 are included in TABLE 1.

TABLE 1
Properties of S1 and S2

| | | Fiber Volume | | |
|---|---|---|---|---|
| | Thickness | Fraction | | |
| Sample | (mm) | (%) | Mean RFAC | COV |
| 1 | 0.15 | 65.9 | 71.6 | 9.4 |
| 2 | 0.16 | 60.6 | 74.4 | 6.8 |

The data used to determine the mean RFAC and COV of S1 and S2 is provided in TABLE 2 and TABLE 3, respectively.

TABLE 2
Data used to Determine mean RFAC and COV of S1

| | | Fiber Area | Box Area | |
|---|---|---|---|---|
| Box | Fiber Count | (cm²) | (cm²) | Area Coverage |
| 1 | 167 | 6.43E−05 | 0.0001 | 64.3 |
| 2 | 143 | 5.50E−05 | 0.0001 | 55.0 |
| 3 | 121 | 4.66E−05 | 0.0001 | 46.6 |
| 4 | 140 | 5.39E−05 | 0.0001 | 53.9 |
| 5 | 154 | 5.93E−05 | 0.0001 | 59.3 |
| 6 | 164 | 6.31E−05 | 0.0001 | 63.1 |
| 7 | 141 | 5.43E−05 | 0.0001 | 54.3 |
| 8 | 131 | 5.04E−05 | 0.0001 | 50.4 |
| 9 | 141 | 5.43E−05 | 0.0001 | 54.3 |
| 10 | 155 | 5.97E−05 | 0.0001 | 59.7 |
| 11 | 150 | 5.77E−05 | 0.0001 | 57.7 |

TABLE 3
Data used to Determine mean RFAC and COV of S2

| | | Fiber Area | Box Area | |
|---|---|---|---|---|
| Box | Fiber Count | (cm²) | (cm²) | Area Coverage |
| 1 | 151 | 5.81E−05 | 0.0001 | 58.1 |
| 2 | 150 | 5.77E−05 | 0.0001 | 57.7 |
| 3 | 133 | 5.12E−05 | 0.0001 | 51.2 |
| 4 | 156 | 6.00E−05 | 0.0001 | 60.0 |
| 5 | 160 | 6.16E−05 | 0.0001 | 61.6 |
| 6 | 147 | 5.66E−05 | 0.0001 | 56.6 |
| 7 | 151 | 5.81E−05 | 0.0001 | 58.1 |
| 8 | 163 | 6.27E−05 | 0.0001 | 62.7 |
| 9 | 167 | 6.43E−05 | 0.0001 | 64.3 |
| 10 | 137 | 5.27E−05 | 0.0001 | 52.7 |
| 11 | 155 | 5.97E−05 | 0.0001 | 59.7 |

### Example 2

### Comparative UD Tape

A commercially available glass fiber UD tape (C1) was analyzed. A cross-sectional image of C1 is shown in FIG. 1. C1 had a mean RFAC of 65.7 and a COV of 32.4. The data used to determine this mean RFAC and COV is provided in TABLE 4.

TABLE 4
Data used to Determine mean RFAC and COV of C1

| | | Fiber Area | Box Area | |
|---|---|---|---|---|
| Box | Fiber Count | (cm²) | (cm²) | Area Coverage |
| 1 | 28 | 6.36E−05 | 0.0001 | 63.6 |
| 2 | 16 | 3.63E−05 | 0.0001 | 36.3 |
| 3 | 30 | 6.81E−05 | 0.0001 | 68.1 |
| 4 | 11 | 2.5E−05 | 0.0001 | 25.0 |
| 5 | 21 | 4.77E−05 | 0.0001 | 47.7 |
| 6 | 28 | 6.36E−05 | 0.0001 | 63.6 |
| 7 | 29 | 6.58E−05 | 0.0001 | 65.8 |
| 8 | 25 | 5.67E−05 | 0.0001 | 56.7 |
| 9 | 29 | 6.58E−05 | 0.0001 | 65.8 |
| 10 | 23 | 5.22E−05 | 0.0001 | 52.2 |
| 11 | 10 | 2.27E−05 | 0.0001 | 22.7 |

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A method for producing a unidirectional fiber tape, the method comprising:
spreading a first set of one or more fiber bundles into a first spreaded fiber layer;
spreading a second set of one or more fiber bundles into a second spreaded fiber layer having at least 10% more fibers than the first spreaded fiber layer;
introducing matrix material into the second spreaded fiber layer at least by:
moving the second spreaded fiber layer underneath and relative to an outlet of a die of an extruder; and
extruding matrix material through the outlet; and
producing the tape at least by pressing the first and second spreaded fiber layers together.

2. The method of claim 1, wherein the second set of one or more fiber bundles includes at least one more fiber bundle than the first set of one or more fiber bundles.

3. The method of claim 1, wherein introducing matrix material into the second spreaded fiber layer is performed such that:
the second spreaded fiber layer is moved in a first direction underneath and relative to the outlet of the die; and
matrix material is extruded through the outlet in an extrusion direction that is perpendicular to or has a component that is counter to the first direction.

4. A method for producing a unidirectional fiber tape, the method comprising:
spreading a first set of one or more fiber bundles into a first spreaded fiber layer;
spreading a second set of one or more fiber bundles into a second spreaded fiber layer;
introducing matrix material into the second spreaded fiber layer at least by:
moving the second spreaded fiber layer in a first direction underneath and relative to an outlet of a die of an extruder; and
extruding matrix material through the outlet in an extrusion direction that is perpendicular to or has a component that is counter to the first direction; and
producing the tape at least by pressing the first and second spreaded fiber layers together.

5. The method of claim 4, wherein the second spreaded fiber layer has at least 10% more fibers than the first spreaded fiber layer.

6. The method of claim 5, wherein the second set of one or more fiber bundles includes at least one more fiber bundle than the first set of one or more fiber bundles.

7. The method of any of claims 3-6, wherein:
extruding matrix material through the outlet of the die comprises conveying matrix material through an interior passageway of the die and to the outlet; and
the extrusion direction is parallel to a longitudinal axis of the interior passageway and/or perpendicular to a plane of the outlet.

8. The method of claim 7, wherein an angle between the first direction and the extrusion direction is between approximately 85 degrees and 90 degrees.

9. The method of any of claims 1-6, wherein, during pressing the first and second spreaded fiber layers together:
the first spreaded fiber layer has a first width; and
the second spreaded fiber layer has a second width that is substantially equal to the first width.

10. The method of any of claims 1-6, comprising:
passing the second spreaded fiber layer underneath a scraper having a downstream portion and an upstream portion;
wherein a distance between the second spreaded fiber layer and the upstream portion is larger than a corresponding distance between the second spreaded fiber layer and the downstream portion such that matrix material accumulates between the scraper and the second spreaded fiber layer.

11. The method of claim 10, wherein the scraper is coupled to the die.

12. The method of any of claims 1-6, wherein a pressure within the extruder is between approximately 5 bar gauge and approximately 25 bar gauge.

13. The method of any of claims 1-6, wherein the first and second sets of one or more fiber bundles comprise unsized fibers.

14. The method of any of claims 1-6, wherein the first and second sets of one or more fiber bundles comprise carbon fibers, glass fibers, aramid fibers, polyethylene fibers, polyamide fibers, basalt fibers, steel fibers, or a combination thereof.

15. The method of claim 14, wherein the first and second sets of one or more fiber bundles comprise carbon fibers or glass fibers.

16. The method of any of claims 1-6, wherein the matrix material comprises a thermoplastic material comprising polyethylene terephthalate (PET), a polycarbonate (PC), polybutylene terephthalate (PBT), poly(1,4-cyclohexylidene cyclohexane-1,4-dicarboxylate) (PCCD), glycol modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polysulfone sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof.

17. The method of claim 16, wherein the thermoplastic material comprises polycarbonate, a polyamide, a copolymer thereof, or a blend thereof.

18. The method of any of claims 1-6, wherein the matrix material comprises a thermoset material comprising an unsaturated polyester resin, a polyurethane, bakelite, duroplast, urea-formaldehyde, diallyl-phthalate, epoxy resin, an epoxy vinylester, a polyimide, a cyanate ester of polycyanurate, dicyclopentadiene, a phenolic, a benzoxazine, a copolymer thereof, or a blend thereof.

19. The method of any of claims 1-6, wherein the tape has a fiber volume fraction that is greater than or equal to 35%.

20. The method of claim 19, wherein the fiber volume fraction is greater than 50%.

21. The method of claim 20, wherein the fiber volume fraction is less than or equal to 70%, optionally, the fiber volume fraction is between 65% and 70%.

22. The method of any of claims 1-6, wherein the tape has a thickness that is between 0.07 millimeters (mm) and 0.30 mm.

23. The method of claim 22, wherein the thickness is between 0.10 mm and 0.25 mm, optionally, the thickness is approximately 0.15 mm.

24. The method of any of claims 1-6, wherein the tape has a mean relative fiber area coverage (RFAC) (%) of from 65 to 90 and a coefficient of variance (COV) (%) of from 3 to 20.

25. The method of claim 24, wherein the mean RFAC is from 70 to 90 and the COV is from 3 to 15.

26. The method of claim 25, wherein the mean RFAC is from 75 to 90 and the COV is from 3 to 10.

27. A method for producing a unidirectional fiber tape, the method comprising:
spreading a first set of one or more fiber bundles into a first spreaded fiber layer;
spreading a second set of one or more fiber bundles into a second spreaded fiber layer;
introducing matrix material into the second spreaded fiber layer using an extruder, the matrix material comprising a thermoplastic material; and
producing the tape at least by pressing the first and second spreaded fiber layers together;
wherein the tape has:
a mean RFAC of from 65 to 90 and a COV of from 3 to 20; and
a thickness that is between 0.07 mm and 0.30 mm.

28. The method of claim 27, wherein the mean RFAC is from 70 to 90 and the COV is from 3 to 15.

29. The method of claim 28, wherein the mean RFAC is from 75 to 90 and the COV is from 3 to 10.

30. The method of claim 27, wherein the first and second sets of one or more fiber bundles comprise carbon fibers, glass fibers, aramid fibers, basalt fibers, or a combination thereof.

31. The method of claim 30, wherein the first and second sets of one or more fiber bundles comprise carbon fibers or glass fibers.

32. A method for producing a unidirectional fiber tape, the method comprising:
spreading a first set of one or more fiber bundles, each comprising carbon fibers, into a first spreaded fiber layer;
spreading a second set of one or more fiber bundles, each comprising carbon fibers, into a second spreaded fiber layer;
introducing matrix material into the second spreaded fiber layer using an extruder, the matrix material comprising a thermoplastic material; and
producing the tape at least by pressing the first and second spreaded fiber layers together;
wherein the tape has:
a fiber volume fraction that is greater than 50%; and
a thickness that is between 0.07 mm and 0.30 mm.

33. The method of claim 32, wherein the fiber volume fraction is less than or equal to 70%, optionally, the fiber volume fraction is between 65% and 70%.

34. The method of claim 27, wherein:
the thermoplastic material comprises polycarbonate;
the first and second sets of one or more fiber bundles each comprise carbon fibers; and
the mean RFAC is approximately 71.6 and the COV is approximately 9.4; or
the mean RFAC is approximately 74.4 and the COV is approximately 6.8.

35. The method of any of claims 27-33, wherein the thermoplastic material comprises polyethylene terephthalate (PET), a polycarbonate (PC), polybutylene terephthalate (PBT), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), a polyamide (PA), polysulfone sulfonate (PSS), polyaryl ether ketone (PAEK), acrylonitrile butyldiene styrene (ABS), polyphenylene sulfide (PPS), polyether sulfone (PES), a copolymer thereof, or a blend thereof.

36. The method of claim 35, wherein the thermoplastic material comprises polycarbonate, a polyamide, a copolymer thereof, or a blend thereof.

37. The method of claim 31, wherein the thickness of the tape is between 0.10 mm and 0.25 mm, optionally, the thickness of the tape is approximately 0.15 mm.

38. A system for producing a unidirectional fiber tape, the system comprising:
an extruder having a die that defines an outlet;
a first set of guiding elements configured to contact a first spreaded fiber layer to guide the first spreaded fiber layer over the die;
a second set of guiding elements that includes:
a first guiding element disposed upstream of the outlet; and
a second guiding element disposed downstream of the outlet;
wherein the first and second guiding elements are configured to contact a second spreaded fiber layer to guide the second spreaded fiber layer in a first direction underneath the outlet; and
one or more pressing elements disposed downstream of the die and configured to press the first and second spreaded fiber layers together;
wherein the extruder is configured to extrude matrix material through the outlet of the die in an extrusion direction that is perpendicular to or has a component that is counter to the first direction.

39. The system of claim 38, wherein an angle between the first direction and the extrusion direction is between approximately 85 degrees and 90 degrees.

40. The system of claim 38 or 39, comprising:
a scraper positioned downstream of the outlet, the scraper having a downstream portion and an upstream portion;
wherein, optionally, the second guiding element comprises the scraper; and
wherein, when the second spreaded fiber layer is guided by the second set of guiding elements, a distance between the second spreaded fiber layer and the upstream portion is larger than a corresponding distance between the second spreaded fiber layer and the downstream portion.

41. The system of claim 40, wherein the scraper is coupled to the die.

42. The system of claim 38 or 39, wherein at least one of the guiding elements comprises a bar or a plate.
